(19) United States
(12) Patent Application Publication
(10) Pub. No.: US 2003/0058906 A1
(43) Pub. Date: Mar. 27, 2003

(54) System and method for the electronic control of a laser diode and thermoelectric cooler

(76) Inventors: John Finn, North Wales, PA (US); Renfeng Gao, Phoenixville, PA (US); Chia-Chi Teng, Piscataway, NJ (US)

Correspondence Address: Finnegan, Henderson, Farabow,, Garrett & Dunner, L.L.P., 1300 I Street, N.W., Washington, DC, 20005-3315, US

(21) Appl. No.: 10/211,135

(22) Filed: Aug. 5, 2002

Related U.S. Application Data
(60) Provisional application No. 60/309,817, filed on Aug. 3, 2001.
(60) Provisional application No. 60/340,957, filed on Dec. 19, 2001.

(51) Int. Cl. H01S 3/04

(52) U.S. Cl. 372/34

(57) ABSTRACT

A system and method for electronically controlling the temperature of a pump laser or laser diode controls temperature uses methods of sourcing drive current. Further, the system shuts off the laser diode and/or a thermoelectric cooler when the temperature of the pump laser exceeds a predetermined amount.

### GOVERNMENT LICENSE RIGHTS

The U.S. Government has a paid-up license in this invention and the right in limited circumstances to require the patent owner to license others on reasonable terms as provided for by the terms of Contract No. N00014-00C-0117 awarded by the U.S. Navy.

### RELATED APPLICATIONS

The present application is related to and claims the benefit of U.S. Provisional Application No. 60/309,817 filed Aug. 3, 2001, in the names of John FINN and Chia-Chi TENG, titled METHOD OF ELECTRONIC CONTROL OF A LASER DIODE AND THERMO-ELECTRIC COOLER USING ULTRA-LOW POWER CONSUMPTION TECHNIQUES and U.S. Provisional Application No. 60/340,957 filed Dec. 19, 2001, in the names of John FINN, Renfeng GAO, and Chia-Chi TENG, titled SYSTEM AND METHOD OF ELECTRONIC CONTROL OF A LASER DIODE AND THERMO-ELECTRIC COOLER USING ULTRA-LOW POWER CONSUMPTION TECHNIQUES, the entire contents of which are relied on and fully incorporated herein by reference.

### FIELD OF THE INVENTION

The present invention relates generally to the control of active components, and more particularly to a method and system for controlling the temperature of lasers and laser diodes.

### BACKGROUND OF THE INVENTION

Lasers, and laser diodes in particular, contain three elements that define their properties. The first, the laser medium, is the material from which light is generated and can be composed of a gas, solid, or liquid. The conditions under which the laser will emit light and the properties of the beam of light depend on the particular laser medium. The second, the power supply, excites the laser medium sufficiently to emit light. The third, the resonator, concentrates the light to stimulate emission of laser radiation. Together, these elements generate an emission of light that is both monochromatic and coherent, distinguishing laser diodes from light emitting diodes (LEDs). LEDs emit light that is the result of spontaneously recombining photons, and as such, the spectrum of the emitted light is much broader than the spectrum of the light emitted by a laser.

Presently, lasers diodes are used in a wide variety of applications, for example, laser pointers, bar code readers, and CD players. With respect to the power requirements for laser diodes, as more power is needed to excite the laser medium, the temperature at which the laser diode operates increases. Laser diodes are sensitive to power overshoots and fluctuations, so that laser diodes require stable power supplies. If the supplied power exceeds a threshold requirement of the laser diode, even for a small period of time, the laser diode will likely fail. Therefore, laser diodes require that the circuitry used to implement their power supplies be chosen with emphasis on protecting the laser diode from excessive current or temperature.

Analog control loops can be used to control and monitor a laser diode's temperature. A general approach to designing analog control loops for active optical devices is to use power operational amplifiers and power transistors. However, using power operational amplifiers and transistors has several drawbacks. For example, this approach is costly. Second, power operational amplifiers and power transistors use a large amount of printed circuit board area. Therefore, it is inefficient to use these devices in applications where space is critical such as, for example, in telecommunications systems, pump controllers, continuous wave distributed feedback (CW DFB) laser controllers, Bragg gratings, temperature controllers, heater element controls, thermoelectric (TEC) controllers, L Band/C Band/S Band drivers, Raman amp controls, and semiconductor optical amplifier (SOA) driver controls. Third, using power operational amplifiers and power transistors gives rise to thermal inefficiencies, which may lead to the degradation of the laser diode. Since many applications using laser diodes require lower power consumption, as in telecommunication systems, the existing hardware is difficult to integrate into these applications.

It is therefore desirable to provide a temperature control system for lasers and laser diodes that overcomes the above described problems and disadvantages of present systems.

### SUMMARY OF THE INVENTION

There is provided a system for electronically controlling a temperature of a pump laser that includes a laser diode, having an on-state and an off-state, a laser diode driver for providing a first input current to operate the laser diode, a cooler, and a cooler driver for providing a second input current to operate the cooler, the system comprising: a temperature detector to determine the pump laser temperature; and a temperature controller, coupled to receive the first input current and responsive to the pump laser temperature, for permitting the laser diode driver to supply the first input current if the pump laser temperature is within a first predetermined temperature range, and to sufficiently block the first input current to render the laser diode inoperable if the pump laser temperature is outside the first predetermined temperature range.

There is also provided a system for electronically controlling a temperature of a laser diode that is operable in an on-state and inoperable in an off-state, comprising: means for determining the laser diode temperature; a cooler for providing heat transfer to lower the laser diode temperature; a laser diode driver for supplying a first input current to drive the laser diode; a temperature controller, coupled to receive the first input current and responsive to the laser diode temperature, for permitting the laser diode driver to supply the first input current if the laser diode temperature is within a first predetermined temperature range, and to reduce the first input current sufficiently to render the laser diode inoperable if the laser diode temperature is outside the first predetermined temperature range; and a cooler driver for supplying a second input current to drive the cooler.

Additional features and advantages will be set forth in part in the description which follows, and in part will be obvious from the description, or may be learned by practice of the claims. The features and advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments of the invention and together with the description, serve to explain the principles of the invention. In the drawings:

FIG. 1 is a block diagram of a system for electronically controlling the temperature of a pump laser consistent with the invention.

FIG. 2 is a circuit diagram further detailing a system for electronically controlling the temperature of a pump laser consistent with the invention.

FIG. 3 is a flowchart of a method for electronically controlling the temperature of a laser diode.

It is to be understood that both the foregoing general description and the following detailed description are exemplary and explanatory only and are not restrictive of the invention, as claimed.

### DETAILED DESCRIPTION

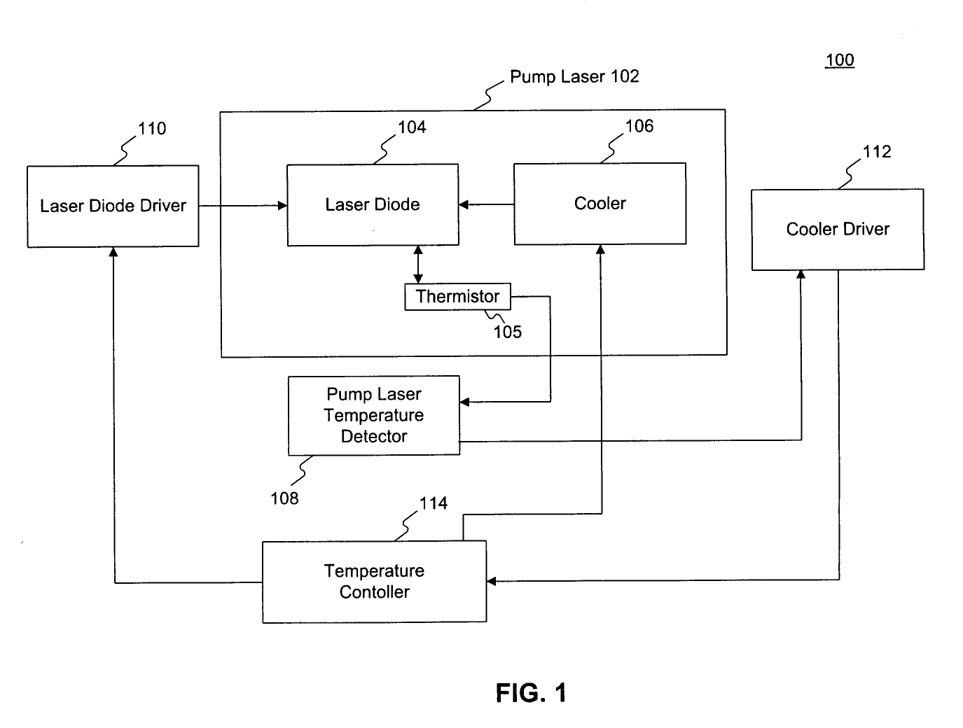

Referring now to the drawings, in which the same reference numbers will be used throughout the drawings to refer to the same or like parts, FIG. 1 is a block diagram of a system 100 for electronically controlling the temperature of a pump laser. System 100 includes a pump laser 102. Pump laser 102 may include a laser diode 104, a thermistor 105, which monitors and detects the temperature of pump laser 102, and a cooler 106, to provide heat transfer away from laser diode 104. System 100 may also include a detector 108, which detects and produces a signal in accordance with and as a function of the temperature of pump laser 102. System 100 may further include a laser diode driver 110 to supply current to laser diode 104, a cooler driver 112 to supply current to cooler 106, and a temperature controller 114, which allows drivers 110 and 112 to supply current or to block the supplied current. Cooler driver 112 is coupled to temperature controller 114. Temperature controller 114 is also coupled to cooler 106 and laser diode driver 110.

As pump laser 102 operates, thermistor 105, which is physically mounted near laser diode 104, monitors the temperature of pump laser 102. Thermistor 105 includes a resistance that varies as a function of temperature and that variation is used to vary a voltage that represents the temperature of pump laser 102. This function of monitoring the temperature can also be performed and implemented by other devices such as a semiconductor-type sensor that varies a voltage as a function of temperature. Thermistor 105 is coupled to detector 108, so that detector 108 can detect the temperature of pump laser 102 and produce a signal representative of the temperature of pump laser 102. The signal output of detector 108 is sent to cooler driver 112, which supplies current to cooler 106 for heat transfer away from laser diode 104. Cooler 106, for example, can be a thermoelectric cooler (TEC) with a maximum required current of 1.50 A. When system 100 is implemented with a TEC having the maximum required current of 1.50 A, cooler driver 112 and cooler 106 can be designed to maintain the pump laser temperature at a near constant temperature of +25° C.+/−1° C. Temperature controller 114 receives the signal, produced by detector 108, representative of the temperature of pump laser 102 via cooler driver 112 and compares the temperature of pump laser 102 with a first predetermined temperature range. The first predetermined temperature range is selected to allow pump laser 102 to operate without burnout due to excessive temperature, so long as the temperature of pump laser 102 remains within the first temperature range. Temperature controller 114 sends a signal to laser diode driver 110 to allow or prevent current from being supplied to laser diode 104, and may also allow or prevent current from being supplied to cooler 106 by cooler driver 112.

The selection of the first predetermined temperature range depends upon the particular operational characteristics and specifications of pump laser 102, for example, a 980 nm pump laser. The first predetermined temperature range can be between 0° C. and 70° C., the operational temperature range for a 980 nm pump laser when laser diode driver 110 is operating in a constant current mode of 0.600 A. In addition, if operating in the constant current mode, backfacet photodiode current does not have to be monitored. A backfacet photodiode is a diode that can produce an electrical signal proportional to the light incident upon it from, for example, laser diode 104. Since the backfacet photodiode current is not being monitored, it eliminates the need for further control circuitry, which decreases printed circuit board size and power consumption requirements. Also, because of the decrease in component count, circuit reliability is increased. If the temperature of pump laser 102 is outside the first predetermined temperature range, temperature controller 114 prevents the operation of pump laser 102. Specifically, if the temperature of pump laser 102 is outside the first predetermined temperature range, temperature controller 114 sends a signal to laser diode driver 110 to sufficiently reduce or block the current supplied to laser diode 104 so that laser diode 104 is rendered inoperable. In addition, temperature controller 114 may also sufficiently reduce or block the drive current to cooler 106, to render cooler 106 inoperable. Conversely, if the pump laser temperature is within the first predetermined temperature range, temperature controller 114 sends a signal to allow laser diode driver 110 to supply sufficient current for operation of laser diode 104 and allows cooler 106 to operate.

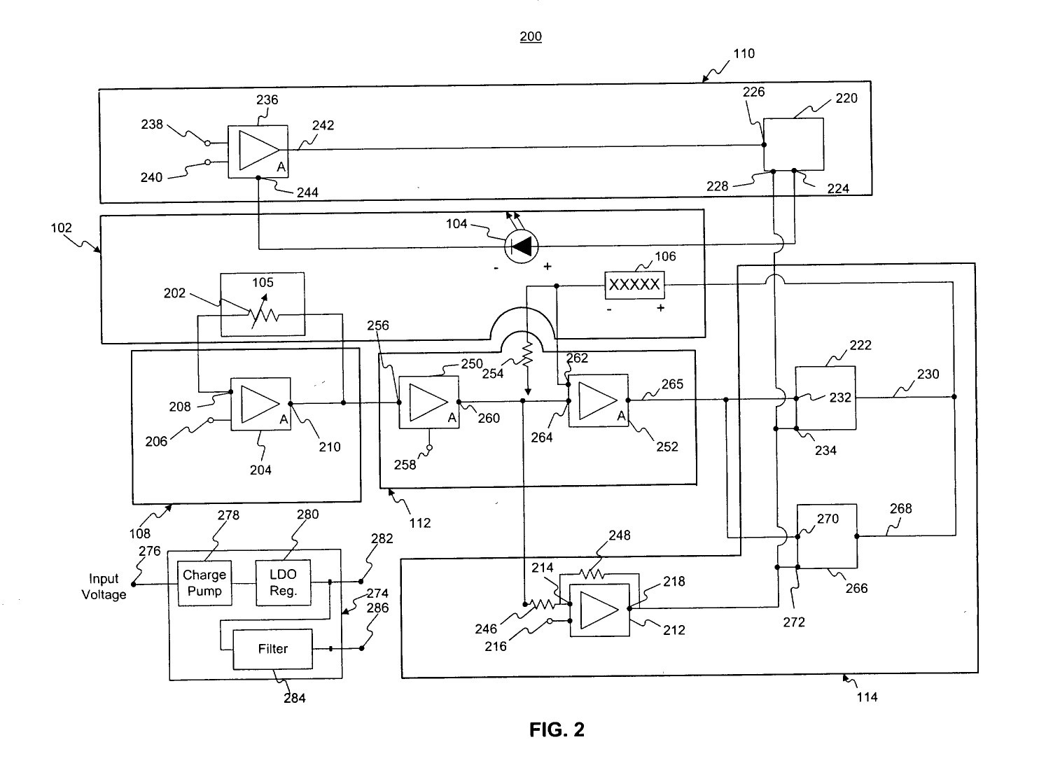

The first predetermined temperature range can also be +15° C. to +30° C. and, as described in further detail with regard to FIG. 2, the pump laser temperature can be maintained at a near constant temperature of +25° C.+/−1° C.

FIG. 2 is a circuit diagram illustrating the features of a system 200, consistent with the present invention, for electronically controlling the temperature of a pump laser. In system 200, thermistor 105 has an electrical resistance 202 that varies as a function of temperature in a predictable manner.

Detector 108 may include a non-inverting amplifier 204. Non-inverting amplifier 204 may include a fixed voltage reference input 206, an amplifier input 208, and an amplifier output 210.

Laser diode driver 110 may include a step down regulator 220 and an amplifier 236. Step down regulator 220 may include a regulator output 224, a driver input 226, and an enable input 228. Amplifier 236 may include a fixed voltage reference input 238, a laser diode current setpoint input 240, a laser diode driver output 242, and a laser diode driver input 244. Depending on the characteristics of laser diode 104, a laser diode current setpoint applied to input 240 is determined by the user to drive laser diode 104 at a level acceptable for the operational characteristics of laser diode 104. Laser diode driver output 242 is coupled to driver input 226, regulator output 224 is coupled to laser diode 104, and laser driver input 244 is also coupled to laser diode 104, such that a current loop is formed between amplifier 236, step down regulator 220, and laser diode 104.

Cooler driver 112 may include a non-inverting amplifier 250, a non-inverting amplifier 252, and a pull down resistor 254. The purpose of cooler driver 112 is to supply input current to cooler 106 (through temperature controller 114), if the pump laser temperature is above a second predetermined temperature. The second predetermined temperature can be selected so that pump laser 102 operates at a near constant temperature, for example 25° C.+/−1° C. Thereby, laser diode 104 is cooled if the pump laser temperature is above the second predetermined temperature. The effect of cooler 106 providing heat transfer away from laser diode 104 is to maintain the overall laser temperature at a near constant value (e.g., 25° C.+/−1° C.). Like laser diode 104, cooler 106 can be rendered inoperable as well, by sufficiently reducing or blocking the current applied to cooler 106 by cooler driver 112, if the temperature of pump laser 102 is outside the first predetermined temperature range as previously described.

Non-inverting amplifier 250 may include an amplifier input 256, a cooler temperature setpoint input 258, and an amplifier output 260. Amplifier output 210 is coupled to input 256 of non-inverting amplifier 250. The signal on amplifier input 256 is compared against a signal applied to cooler temperature setpoint input 258, which is the second predetermined temperature selected by the user according to the desired temperature at which pump laser 102 is to be maintained (e.g., 25° C.+/−1° C.). Cooler temperature setpoint input 258 can be generated from a voltage divider circuit which derives its source voltage from a fixed voltage reference.

Non-inverting amplifier 252 may include a cooler input 262, an amplifier input 264, and an amplifier output 265. Cooler input 262 is coupled to cooler 106 and pull down resistor 254. Pull down resistor 254 facilitates stable operation of cooler input 262 by eliminating noise or spurious signals that may affect amplifier 252. Amplifier input 264 is coupled to amplifier output 260. The signal on amplifier output 260 that is representative of the temperature of pump laser 102 is amplified by non-inverting amplifier 252 to produce a signal on amplifier output 265. For example, non-inverting amplifier 250 generates a difference voltage which is then used to drive non-inverting amplifier 252. Using a difference voltage allows step down regulators 222 and 266 of temperature controller 114 to respond to differences in values of thermistor 105 and also for limits to be placed on non-inverting amplifier 252, as previously described. Therefore, when cooler 106 is in operation, heat is transferred away from laser diode 104 and the temperature of pump laser 102 is lowered. Pull down resistor 254 also ensures that signal noise or spurious signals do not interfere with the operation of non-inverting amplifier 252.

Temperature controller 114 may include a comparator 212, having a comparator input 214, a fixed voltage reference input 216, a comparator output 218, an input resistor 246, and a feedback resistor 248. Comparator input 214 is coupled to input resistor 246, and input resistor 246 is coupled to amplifier output 260 of non-inverting amplifier 250. Comparator input 214 is also coupled to feedback resistor 248 and feedback resistor 248 is coupled to comparator output 218, so that a feedback gain section is formed on comparator 212. Temperature controller 114 may further include step down regulator 222 and step down regulator 266. Step down regulator 222 includes a regulator output 230, a driver input 232, and an enable input 234. Driver input 232 is coupled to receive the drive current from cooler driver 112. Enable input 234 is coupled to receive a signal on comparator output 218. In addition, comparator output 218 is also coupled to enable input 228 of step down regulator 220. Step down regulator 266 includes a regulator output 268, a driver input 270, and enable input 272. Driver input 270 is coupled to driver 232, enable input 272 is coupled to enable input 234, and regulator output 268 is coupled to regulator output 230. Although FIG. 2 shows two shut down regulators for cooler 106 (shutdown regulators 222 and 266), more or fewer shutdown regulators could be used depending on the current requirements of the application. For example, in higher current applications, such as a 980 nm pump laser, two or more shutdown regulators are desirable. If the application only requires low current delivery, a single stepdown regulator is sufficient.

As system 200 operates, pump laser 102 is in its “on” state, whereby laser diode 104 is being supplied current by laser diode driver 110, cooler 106 is being supplied current by cooler driver 112, and thermistor 105 is monitoring the temperature of pump laser 102. Thermistor 105 is physically mounted near laser diode 104 to monitor the temperature of pump laser 102. Depending on the monitored temperature of pump laser 102, the value of variable resistance 202, coupled between amplifier input 208 and amplifier output 210, varies as a function of the temperature. Therefore, thermistor 105 forms a non-inverting feedback gain section for non-inverting amplifier 204. As a result, a signal on amplifier output 210 is representative of the temperature of pump laser 102 and is coupled to cooler driver 112.

Cooler 106 is controlled by using non-inverting amplifier 250 as a difference amplifier. The signal on amplifier input 256 may have a scaled voltage based on variable resistance 202, which is a signal representative of the temperature of pump laser 102. Cooler temperature setpoint input 258 can be chosen by the user according to the desired application. As discussed earlier, cooler temperature setpoint input 258 can be generated from a voltage driver circuit which derives its source voltage from a fixed voltage reference. For ordinary applications, cooler temperature setpoint input 258 can be fixed. If the difference between amplifier input 256 and cooler temperature setpoint input 258 is large, then there will be a corresponding increase in the driving current supplied to cooler 106. If there is a small variation in the difference voltage, then the corresponding value for the drive current supplied to cooler 106 will be small. The output of non-inverting amplifier 250 provided on amplifier output 260, is a signal representative of the temperature of pump laser 102, i.e., a signal value that varies as a function of the temperature of pump laser 102. For example, if cooler 106 is trying to maintain the temperature of pump laser 102 at +25° C., then variable resistance 202 is 10.0 kΩ and a nominal value of a voltage sample for thermistor 105 is 3.58V+/−0.5 V. The value of the voltage sample output should be limited to a value that is near the midpoint of a corresponding sample amplifier's output range.

Operating cooler driver 112 as a function of the difference between two voltages, e.g., the difference between the voltage representative of the temperature of pump laser 102 and voltage representative of cooler temperature setpoint input 258, rather than a single control voltage, allows for better rejection of control voltages that are caused by random noise or elevated noise levels from extraneous offset values.

Temperature controller 114 operates in the following manner. Comparator 212 may output one of two signals (e.g., a logic level low or logic level high) on comparator output 218. This signal is provided to step down regulator 220 through enable input 228, to step down regulator 222 through enable input 234, and to step down regulator 266 through enable input 272. Whether the signal on comparator output 218 is a logic level high or low depends on whether the temperature of pump laser 102 is within the first predetermined temperature range or outside the first predetermined temperature range.

Generally, comparator output 218 may be a logic level low, if the pump laser temperature is outside the first predetermined temperature range. If comparator output 218 is a logic level low, enable input 228, enable input 234, and enable input 272 also receive a logic level low signal. In response, step down regulator 220 is disabled and this prevents amplifier 236 from supplying current sufficient to allow operation of laser diode 104, thereby rendering laser diode 104 inoperable. Also, since enable input 234 and enable input 272 receive logic level low signals, step down regulators 222 and 266 are disabled, preventing cooler driver 112 from supplying current sufficient for operation of cooler 106 and rendering cooler 106 inoperable. Thermistor 105 continues to monitor the temperature of pump laser 102, so that detector 108 produces a signal on amplifier output 210 that corresponds to the temperature of pump laser 102.

Comparator output 218 may be a logic level high if the pump laser temperature is within the first predetermined temperature range. If comparator output 218 is a logic level high, enable input 228, enable input 234, and enable input 272 also receive a logic level high signal. As a result, step down regulator 220 is enabled, allowing amplifier 236 to supply sufficient current for operation of laser diode 104. Also, since enable input 228 and enable input 234 receive logic level high signals, step down regulators 222 and 266 are also enabled, allowing cooler driver 112 to supply sufficient current for operation of cooler 106. Detector 108 continues to monitor the pump laser temperature, and so long as the pump laser temperature is within the first predetermined range, the signal on amplifier output 210 will cause comparator output 218 to be a logic level high.

The operation of comparator 212 and the selection of the temperature levels corresponding to the first predetermined range are implemented by using the equation for an inverting zero crossing detector, set forth as the following equation (1):

V_{zh}=(Rᵢ*Vₛ)/(Rᵢ+R_{f}); (1)

where V_{zh} is a threshold voltage for comparator 212; Rᵢ is the input resistance for comparator 212 (input resistor 246); R_{f} is the feedback resistance into comparator 212 (feedback resistor 248); and Vₛ is the maximum output voltage for comparator 212. An input voltage to comparator 212, e.g., the voltage on amplifier output 260 is compared against V_{zh}. Rᵢ and R_{f} are chosen by the user so that V_{zh} represents the voltage levels at which comparator output 218 will transition from a logic level high to logic level low or vice versa and depends upon the design selections and requirements of Rᵢ, R_{f}, and Vₛ. For example, in the case of the shutdown limits for pump laser 102 (e.g., the first predetermined temperature range between +15° C. and +30° C.), where fixed voltage reference 216 is 0.0 V, V_{zh} is +/−0.379 V. Therefore, when the voltage on amplifier output 260 is +/−0.379 V, comparator output 218 will transition from a logic level low to a logic level high. Further, in this example, at +15° C. or below, comparator 212 outputs a logic level low, corresponding to a −0.379 V or below on amplifier output 260, thereby shutting down regulators 220, 222, and 266. At +30° C. or higher, comparator 212 outputs a logic level low, corresponding to a +0.379 V or higher on amplifier output 260, thereby shutting down regulators 220, 222, and 266. At temperatures between +15° C. and +30° C., e.g., at +25° C., comparator 212 outputs a logic level high, corresponding to a voltage of 0.0 V on amplifier output 260, allowing regulators 220, 222, and 266 to operate. This, in turn, allows pump laser 102 to operate.

System 200 can be operated using a power supply 274 that has an input 276 of 5V DC with a current of up to 1 A when system 200 operates at +70° C. Power supply 274 can also include a dual channel charge pump 278, a low drop out regulator (LDO) 280, an unfiltered output 282, a filter 284, and a filtered output voltage 286. Power supply 274 can be filtered for low frequency noise using an LC filter at unfiltered output 282 of the LDO regulator 280. Output 282 is filtered through filter 284, and filtered output voltage 286 can be used for supply voltages of detector 108, laser diode driver 110, and comparator 212. Filter 284 can be provided as an LC filter. Specifically, output voltage 286 can be used for fixed voltage reference input 206, fixed voltage reference input 238, cooler temperature setpoint input 258, and fixed voltage reference input 216. With this configuration and values, system 200 has a power consumption that is less that 1 W at 25° C. System 200 is also versatile in that the blocks shown as thermistor 105, detector 108, laser diode driver 110, cooler driver 112 and temperature controller 114 can be substituted for other universal control blocks known in the art.

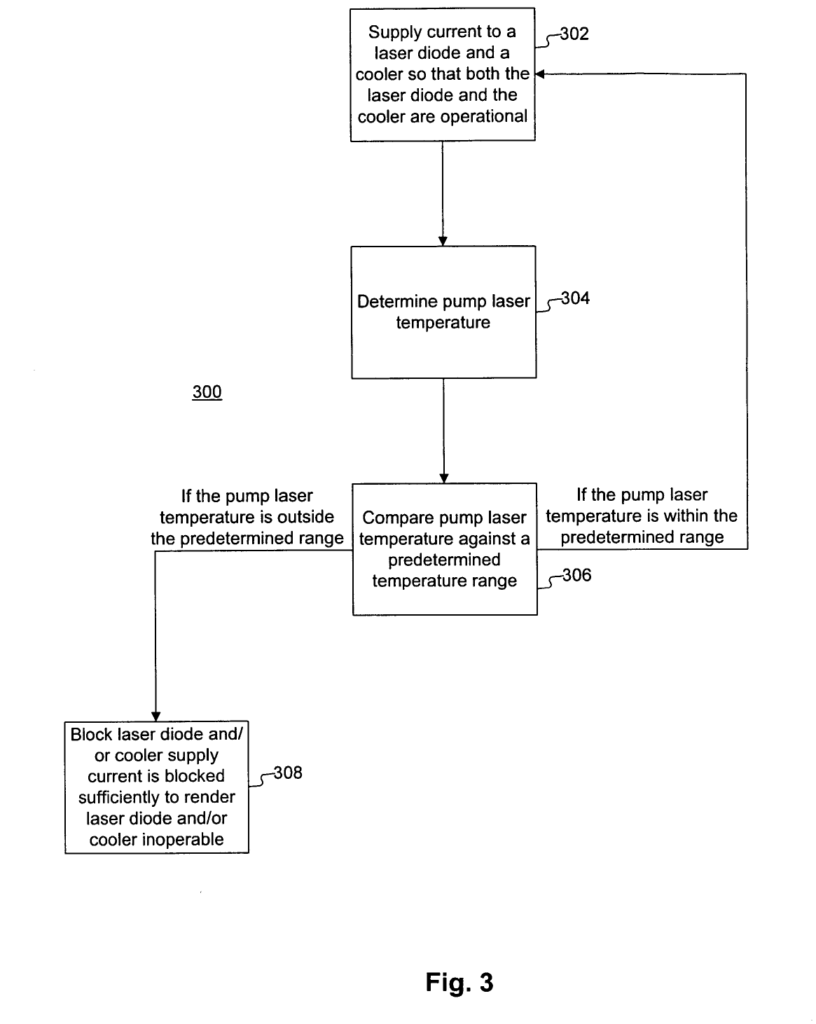

FIG. 3 is a flowchart 300 of a method for electronically controlling the temperature of a pump laser. A method for electronically controlling the temperature of a pump laser begins at a stage 302, where current is supplied to a laser diode and cooler, e.g., from a first input current coupled to the laser diode and a second input current coupled to the cooler. As current is supplied to operate the laser diode and cooler, the temperature of the pump laser is determined at a stage 304. As the pump laser continues to operate and the pump laser temperature is continuously determined, the pump laser temperature is compared to a predetermined temperature range, e.g., a range selected by the user to prevent the burn out of the laser diode, as shown at a stage 306. Two outcomes may result from stage 306. First, if the pump laser temperature is within the predetermined temperature range, current continues to be supplied to the laser diode and cooler sufficient for their operation, as previously described at stage 302. Second, if the pump laser temperature is not within the predetermined temperature range, the supplied current is blocked sufficiently so that the laser diode and/or cooler are inoperable, as shown at a stage 308.

Other embodiments will be apparent to those skilled in the art from consideration of the specification and practice of the claims disclosed herein. It is intended that the specification and examples be considered as exemplary only, with a true scope and spirit being indicated by the following claims.

What is claimed is:

1. A system for electronically controlling a temperature of a pump laser that includes a laser diode, having an on-state and an off-state, and a laser diode driver for providing a first input current to operate the laser diode, the system comprising:
a temperature detector disposed to determine the pump laser temperature; and
a temperature controller, coupled to receive the first input current and responsive to the pump laser temperature, for permitting the laser diode driver to supply the first input current if the pump laser temperature is within a first predetermined temperature range, and to sufficiently reduce the first input current to render the laser diode inoperable if the pump laser temperature is outside the first predetermined temperature range.

2. The system of claim 1, wherein the temperature controller comprises:
a comparator, coupled to receive a signal representative of the pump laser temperature and a signal representative of the first predetermined temperature range, to compare the pump laser temperature to the first predetermined temperature range, and having a comparator output that has a first value if the pump laser temperature is within the first predetermined temperature range and a second value if the pump laser temperature is outside the first predetermined temperature range.

3. The system of claim 2, wherein the temperature controller further comprises:
a first regulator, coupled to receive the first input current and the comparator output, for allowing the laser diode to be operable when the comparator output is the first value, and rendering the laser diode inoperable when the comparator output is the second value.

4. The system of claim 3, wherein the pump laser further includes a cooler and a cooler driver for providing a second input current to operate the cooler and wherein the temperature controller further comprises:
a second regulator, coupled to receive the second input current and the comparator output, for allowing the cooler to be operable when the comparator output is the first value, and rendering the cooler inoperable when the comparator output is the second value.

5. The system of claim 2, wherein the temperature detector comprises:
a non-inverting amplifier, having a fixed voltage reference first input, a second input, and an amplifier output; and
a thermistor having a resistance that varies in accordance with the pump laser temperature to determine the pump laser temperature signal, the thermistor being coupled between the second input and the amplifier output, so that the pump laser temperature signal corresponds with the amplifier output and the pump laser temperature is maintained within the first predetermined temperature range.

6. The system of claim 4, wherein the temperature detector comprises:
a non-inverting amplifier, having a fixed voltage reference first input, a second input, and an amplifier output; and
a thermistor having a resistance that varies in accordance with the pump laser temperature to determine the pump laser temperature signal, the thermistor being coupled between the second input and the amplifier output, so that the pump laser temperature signal corresponds with the amplifier output and the pump laser temperature is maintained within the first predetermined temperature range.

7. The system of claim 1, wherein the pump laser further includes a cooler and a cooler driver for providing a second input current to operate the cooler and wherein the cooler comprises a thermoelectric cooler.

8. The system of claim 1, wherein the pump laser further includes a cooler and a cooler driver for providing a second input current to operate the cooler and wherein the system has an associated power draw which does not exceed 1 Watt when the pump laser temperature is 25° C.

9. The system of claim 1, wherein the pump laser further includes a cooler and a cooler driver for providing a second input current to operate the cooler and wherein the temperature controller is interposed between the cooler driver and the cooler to control the supply of the second input current responsive to the pump laser temperature so that the pump laser temperature remains at a near constant value.

10. The system of claim 1, wherein the pump laser further includes a cooler and a cooler driver for providing a second input current to operate the cooler, the system further comprising:
means for comparing the pump laser temperature to a second predetermined temperature range and for permitting the cooler driver to supply the second input current if the pump laser temperature is within the second predetermined range and to block the second input current sufficiently to render the cooler inoperable if the pump laser temperature is outside the second predetermined temperature range.

11. A system for electronically controlling a temperature of a laser diode that is operable in an on-state and inoperable in an off-state, comprising:
means for determining the laser diode temperature;
a cooler for providing heat transfer to lower the laser diode temperature;
a laser diode driver for supplying a first input current to drive the laser diode;
a temperature controller, coupled to receive the first input current and responsive to the laser diode temperature, for permitting the laser diode driver, to supply the first input current if the laser diode temperature is within a first predetermined temperature range, and to block the first input current sufficiently to render the laser diode inoperable if the laser diode temperature is outside the first predetermined temperature range; and
a cooler driver for supplying a second input current to drive the cooler.

12. The system of claim 11, wherein the temperature controller comprises:
a comparator, coupled to receive a signal representative of the laser diode temperature, to compare the laser diode temperature to the first predetermined temperature range, and having a comparator output that has a first value if the laser diode temperature is within the first predetermined temperature range and a second value if the laser diode temperature is outside the first predetermined temperature range.

13. The system of claim 12, wherein the temperature controller further comprises:
a first regulator, coupled to receive the first input current and the comparator output, for allowing the laser diode to be operable when the comparator output is the first value, and rendering the laser diode inoperable when the comparator output is the second value.

14. The system of claim 13, wherein the temperature controller further comprises:
a second regulator, coupled to receive the second input current and the comparator output, for allowing the cooler to be operable when the comparator output is the first value, and rendering the cooler inoperable when the comparator output is the second value.

15. The system of claim 12, wherein the means for determining the laser diode temperature comprises:
a non-inverting amplifier, having a fixed voltage reference first input, a second input, and an amplifier output; and
a thermistor having a resistance that varies in accordance with the laser diode temperature to determine the laser diode temperature signal, the thermistor being coupled between the second input and the amplifier output, so that the laser diode temperature signal corresponds with the amplifier output and the laser diode temperature is maintained within the first predetermined temperature range.

16. The system of claim 14, wherein the means for determining the laser diode temperature comprises:
a non-inverting amplifier, having a fixed voltage reference first input, a second input, and an amplifier output; and
a thermistor having a resistance that varies in accordance with the laser diode temperature to determine the laser diode temperature signal, the thermistor being coupled between the second input and the amplifier output, so that the laser diode temperature signal corresponds with the amplifier output and the laser diode temperature is maintained within the first predetermined temperature range

17. The system of claim 11, wherein the cooler comprises a thermoelectric cooler.

18. The system of claim 11, wherein the temperature controller further controls the cooler driver to supply the second input current if the laser diode temperature is within the first predetermined temperature range, and to block the second input current sufficiently to render the cooler inoperable if the laser diode temperature is outside the first predetermined temperature range.

19. The system of claim 11, further comprising:
means for comparing the pump laser temperature to a second predetermined temperature range and permitting the cooler driver to supply the second input current if the laser diode temperature is within the second predetermined range and to block the second input current sufficiently to render the cooler inoperable if the laser diode temperature is outside the second temperature range.

20. A method for electronically controlling a temperature of a pump laser, including a laser diode having an on-state and an off-state, comprising the steps of:
supplying a first input current to the laser diode, which is operable in the on-state and inoperable in the off-state;
supplying a second input current to a cooler which provides heat transfer away from the laser diode;
determining the pump laser temperature;
comparing the pump laser temperature to a first predetermined temperature range; and
permitting the laser diode to be operable by the supplied first input current if the pump laser temperature is within the first predetermined temperature range or sufficiently reducing the supplied first input current to the laser diode to render the laser diode inoperable if the pump laser temperature is outside the first predetermined temperature range.

21. The method of claim 20, wherein comparing comprises receiving a signal representative of the pump laser temperature by a comparator which is also coupled to receive a signal representative of the first predetermined temperature range, the comparator outputting a first value if the pump laser temperature is within the first predetermined temperature range and a second value if the pump laser temperature is outside the first predetermined temperature range.

22. The method of claim 21, wherein permitting comprises a first regulator allowing the laser diode to receive the first input current and to be operable when the comparator output is the first value.

23. The method of claim 22, wherein permitting further comprises a second regulator allowing the second input current to render the cooler operable when the comparator output is the first value.

24. The method of claim 21, wherein sufficiently reducing comprises a first regulator sufficiently reducing the first input current to render the laser diode inoperable when the comparator output is the second value.

25. The method of claim 24, wherein determining comprises determining a resistance of a thermistor that varies in accordance with the pump laser temperature, the resistance being coupled between an input and an amplifier output of a non-inverting amplifier, to determine a pump laser temperature so that the amplifier output corresponds with the pump laser temperature and the pump laser temperature is maintained within the first predetermined temperature range.

26. The method of claim 24, wherein sufficiently reducing further comprises rendering the cooler inoperable when the comparator output is the second value.

27. The method of claim 21 wherein determining comprises determining a resistance of a thermistor that varies in accordance with the pump laser temperature, the resistance being coupled between an input and an amplifier output of a non-inverting amplifier, to determine a pump laser temperature so that the amplifier output corresponds to the pump laser temperature and the pump laser temperature is maintained within the first predetermined temperature range.

28. The method of claim 20, further including providing the cooler as a thermoelectric cooler.

29. The method of claim 20, further comprising the step of permitting the cooler to be operable by the supplied second input current if the pump laser temperature is within the first predetermined temperature range or sufficiently reducing the supplied second input current sufficiently to render the cooler inoperable if the pump laser temperature is outside the first predetermined temperature range.

30. The method of claim 20, further comprising the step of comparing the pump laser temperature to a second predetermined range and permitting the cooler driver to supply the second input current if the pump laser temperature is within the second predetermined range and to sufficiently reduce the second input current to render the cooler inoperable if the pump laser temperature is outside the second predetermined temperature range.

31. A pump laser system for electronically controlling a temperature of a pump laser, having an on-state and an off-state, comprising:
a laser diode, coupled to receive a first input current, operable in the on-state and inoperable in the off-state;
a temperature detector to determine the pump laser temperature;
a cooler, coupled to receive a second input current, to provide heat transfer away from the laser diode;
a laser diode driver for supplying the first input current to drive the laser diode;
a temperature controller, coupled to receive the first input current and responsive to the pump laser temperature, for permitting the laser diode driver to supply the first input current if the pump laser temperature is within a first predetermined temperature range, and to sufficiently reduce the first input current to render the laser diode inoperable if the pump laser temperature is outside the first predetermined temperature range; and
a cooler driver for supplying the second input current to drive the cooler.
